(19) United States
(12) Patent Application Publication
(10) Pub. No.: US 2003/0160786 A1
(43) Pub. Date: Aug. 28, 2003

(54) Automatic determination of borders of body structures

(76) Inventor: Richard K. Johnson, Sammamish, WA (US)

Correspondence Address: Jeffrey Pearce, 34825 Sultan-Startup Rd., Sultan, WA, 98294, US

(21) Appl. No.: 10/376,945

(22) Filed: Feb. 28, 2003

Related U.S. Application Data
(60) Provisional application No. 60/319,132, filed on Feb. 28, 2002.

(51) Int. Cl. G06T 15/00

(52) U.S. Cl. 345/419

(57) ABSTRACT

An imaging system—preferably an ultrasound machine—is used to fit a shape to some portion of a patient's heart or other body structure. Ultrasound imaging is carried out over at least one cardiac cycle, providing a plurality of images made with a transducer at known orientations with respect to the body structure. An operator selects points on some of the images that correspond to the shape of interest, and a shape is automatically fit to the points, using prior knowledge about heart anatomy to constrain the fitted shape to a reasonable result. The operator reviews the fitted shape, in 3D or alternatively, as intersected with the images. If the fit is acceptable, the process is done. Otherwise, the image processing is repetitively carried out, guided by the fitted 3-D shape, to produce additional data points, until an acceptable fit is obtained. The resulting 3-D output shape can be used in determining cardiac parameters.

### CROSS-REFERENCE TO RELATED APPLICATIONS

This application claims priority under 35 U.S.C. §119(e) of U.S. Provisional Patent Application, Serial No. 60/319,132, filed Feb. 28, 2002.

### STATEMENT REGARDING FEDERAL SPONSORSHIP

This invention was made with federal government support under HL-59054 awarded by the National Institutes of Health, and the federal government has certain rights to the invention.

### BACKGROUND OF THE INVENTION

1. Field of the Invention

The present invention generally relates to automatically identifying and delineating the boundary or contour of an internal organ from image data, and more specifically, to automatically delineating the shapes of an organ such as a heart, by processing data from images of such organs.

2. Description of the Related Art

Much effort has been expended over the past 20 years to develop an automated contour delineation algorithm for echocardiograms. The task is difficult because ultrasound images are inherently subject to noise, and the endocardial and epicardial contours comprise multiple tissue elements. At first, attempts were made to trace the ventricular contour from static images. The earliest algorithms were gradient-based edge detectors that searched among the gray-scale values of the image pixels for a transition from light to dark, which might correspond to the border between the myocardium and the blood in a ventricular chamber. It was then necessary to identify those edge segments that should be strung together to form the ventricular contour. This task was typically performed by looking for local shape consistency and avoiding abrupt changes in contour direction. The edge detectors were usually designed to search radially from the center of the ventricle to locate the endocardial and epicardial contours.

These prior art techniques were most applicable to short-axis views. The application of an elliptical model, for example, enabled contour detection in apical views in which the left ventricle appears roughly elliptical in shape; however, the irregular contour in the region of the two valves at the basal end could not be accurately delineated. Another problem with some of the early edge detectors was that they traced all contours of the ventricular endocardium indiscriminately around and between the trabeculae carneae and papillary muscles. Subsequent methods were able to ignore these details of the musculature and to trace the smoother contour of the underlying endocardium.

A matched filtering approach has also been used for contour detection, as reported in “Matched Filter Identification of Left-Ventricular Endocardial Borders in Transesophageal Echocardiograms,” Trans. Med. Imag. 9:396-404 (1990), P. R. Detmer, G. Bashein, and R. W. Martin. This method used a filter computed from average gray-scale values to find contour locations along radial lines from the ventricle center. The method was used only for short-axis views, which provide a closed contour. It was not successful in regions with low a signal-to-noise ratio.

Contour delineation accuracy improved when algorithms began to incorporate information available from tracking the motion of the heart as it contracts and expands with each beat during the cardiac cycle, instead of operating on a single static image. Indeed, human observers almost always utilize this type of temporal information when they trace contours manually. Similarities between temporally adjacent image frames are used to help fill in discontinuities or areas of signal dropout in an image, and to smooth the rough contours obtained using a radial search algorithm. The problems with these prior art methods are: a) the operator generally has to manually trace the ventricular contour or identify a region of interest in the first image of the time series; b) the errors at any frame in the series may be propagated to subsequent frames; and c) the cardiac parameters of greatest clinical interest are derived from analysis of only two time points in the cardiac cycle—end diastole and end systole.

The algorithm developed by Geiser, et al., in “Autonomous epicardial and endocardial boundary detection in echocardiographic short-axis images,” Journal of The American Society of Echocardiography, 11 (4):338-48 (1998) is more accurate in contour delineation than those previously reported. The Geiser, et al., algorithm incorporates not only temporal information, but also knowledge about the expected homogeneity of regional wall thickness by considering both the endocardial and epicardial contours. In addition, knowledge concerning the expected shape of the ventricular contour is applied to assist in connecting edge segments to form a contour.

Geiser's approach has several disadvantages and limitations, among which are: First, the assumption it uses to select and connect edge segments—that the contour is elliptical—may not be valid under certain disease conditions in which the curvature of the interventricular septum is reversed. Second, it captures only short-axis views, although this view is only one of the five standard views used in echocardiography, the other four all being long-axis views. Third, the single view from which Geiger's method determines a shape estimate must pass precisely through certain specified image landmarks, which causes the method to be particularly sensitive to the skill level of the sonographer. Finally, Geigers' method produces an estimate of only a 2-D shape representing the epicardium and endocardium, so that the method cannot determine cardiac parameters such as ejection fraction or cardiac output, which require 3-D information.

Another way to use heart shape information is as a post-processing step. As reported in “Automatic Contour Definition on Left Ventriculograms by Image Evidence and a Multiple Template-Based Model,” IEEE Trans. Med. Imag. 8:173-185 (1989), Lilly, et al., used templates based on manually traced contours to verify the anatomical feasibility of the contours detected by their algorithm, and to make corrections to the contours. This method has only been used for contrast ventriculograms, however, and is probably not applicable to echocardiographic images.

In general, the problem is not to find gray-scale edges, but rather to identify which of the many edges found in each image should be retained and connected to reconstruct the ventricular shape. A number of investigators have moved from connecting contour segments using simple shape models based on local smoothness criteria in space and time, to starting with a closed contour and deforming it to fit the image. An advantage of this approach is that the fitting procedure itself produces a shape reconstruction of the ventricle.

In their paper entitled, “Recovery of the 3-D Shape of the Left Ventricle from Echocardiographic Images,” IEEE Trans. Med. Imag. 14:301-317 (1995), Coppini, et al., explain how they employ a plastic shape, which deforms to fit the gray-scale information, to develop a three-dimensional shape. However their shape is essentially a sphere pulled by springs, and cannot capture the complex anatomic shape of the ventricle with its outflow tract and valves. This limitation is important because analysis of ventricular shape and regional function requires accurate contour detection and reconstruction of the ventricular shape.

A contour detection method that utilizes a knowledge-based model of the ventricular contour, called the “active shape model,” has also been developed. (See T. F. Cootes, A. Hill, C. J. Taylor, and J. Haslam, “Use of Active Shape Models for Locating Structures in Medical Images,” which is included in Information Processing Medical Imaging, edited by H. H. Barrett and A. F. Gmitro, Berlin, Springer-Verlag, pp. 33-47, 1993.) Active shape models use an iterative refinement algorithm to search the image. The principal disadvantage is that the active shape model can be deformed only in ways that are consistent with the statistical model derived from training data. This model of the shape of the ventricle is generated by performing a principal components analysis of the manually traced contours from a set of training images derived from ultrasound studies.

In Cootes' technique, the contours include a number of specific landmarks, which are consistently located, and represent the same point in each study. Each landmark is associated with a profile model passing through it and perpendicular to the local contour, which is determined from the gray-scale characteristics of the training data. Contours are then automatically detected by adjusting each landmark along its profile direction to the point where its model profile best matches the image. A new active shape model is then computed. The Cootes method computes only two-dimensional (2-D) structural estimates and requires that the landmarks be consistently identified and located on all the images; this is generally not possible for a smooth object like a heart ventricle. Moreover, the profiles of this method are normalized by using the derivatives of the image gray-scale levels; this increases noise, which causes the method to work poorly with ultrasound images, which are usually relatively noisy to begin with.

In U.S. Pat. No. 6,106,466, Sheehan, et al., disclose a method that generates mesh model for the left ventricle from a set of training data. The mesh is developed by an archetype and covariance that defines the extent of variation of control vertices in the mesh for the population of training data. The mesh model is rigidly aligned with the images of the patient's heart. Predicted images in planes corresponding to those of the images for the patient's heart and derived from the mesh model are compared to corresponding images of the patient's heart. Control vertices are iteratively adjusted to optimize the fit of the predicted images to the observed images of the patient's heart. This adjustment and comparison continues until an acceptable fit is obtained. In a development of this method—“Integrated Surface Model Optimization for Freehand Three-Dimensional Echocardiography,” Mingzhou Song, et al., IEEE Transactions On Medical Imaging, Vol. 21, No. 9, September 2002 —the problem is formulated in a Bayesian framework, such that the inference made about a shape model is based on the integration of both the low-level image evidence and the high-level prior shape knowledge through a pixel class prediction mechanism. In this approach the shape is modified so that the distance between the data images and images computed from the shape is minimized. This process currently requires a very long computation time.

One common disadvantage of known methods for determining an estimate of a 3-D body structures is that they require the user to input at least initial information about the spatial orientation of the imaged structures. This is often difficult not only because the structures are often complicated, but also because the user must do this based on the 2-D images displayed for him on the screen.

What is needed is therefore a new approach to shape delineation for body features that can provide an anatomically accurate reconstruction in a relatively short time. Especially in the context of ultrasonic imaging of cardiac structures, such a new approach should be able to correctly identify and delineate segments of the ventricular shape; moreover, it should be able to reconstruct both the endocardial and epicardial contours, and to work with images acquired at any time point in the cardiac cycle. This invention provides a system and related method of operation that meets these needs.

### SUMMARY OF THE INVENTION

In accordance with the present invention, a method for delineating the shape of a heart (for example, the heart of a patient) includes the step of imaging the heart to produce imaging data extending through the heart, with identifiable view orientations. The method employs a shape fit using knowledge bases of shapes and images derived from data collected by imaging and tracing (preferably, selecting border points of) shapes of a plurality of other hearts. Several of points on the shape of the heart are identified in each observed image, and the shape is then fit to these points, producing candidate heart borders. The resulting shape may be improved by processing the image in the vicinity of the candidate borders to detect likely border points. The fitting process may be repeated with the addition of these likely border points. The method produces a shape for the patient's heart and detected borders for the images.

The imaging step preferably comprises producing ultrasonic images of the heart using an ultrasonic imaging device disposed at known orientations relative to the patient's heart. In addition, the patient's heart is preferably imaged at a plurality of times during a cardiac cycle, including at an end diastole and at an end systole.

To optimize the fit of the shape to data points derived from the images of the patient's heart, geometry parameters of the shape are iteratively adjusted to optimize a fit quality measure. The fit quality measure includes the distance from the point data to the shape. The distance calculation may be restricted by labeling subsets of both the data and the shape, and measuring distances between labeled data points and the correspondingly labeled parts of the shape. The fit quality measure may also include other criteria such as shape smoothness and the likelihood of observing a heart with the given shape. The method includes the step of determining if the shape of the fitted shape is clinically probable and, thus, acceptable; if not, the operator may elect to manually enter additional points and rerun the fit. Alternatively, additional points may be added automatically.

In a preferred application of the invention, the shape represents the left ventricle of a patient's heart. Preferably, the shape obtained in the disclosed application of the present invention is determined for different parts of a cardiac cycle. However, it is contemplated that the present invention can alternatively be used to determine the shapes and/or borders of other internal organs based on images of the organs.

According to one aspect of the invention, a body structure (such as a heart ventricle) is scanned (preferably using an ultrasound transducer) in a single scan plane to produce a corresponding two-dimensional, cross-sectional image of the body structure. Initial boundary points are selected on a perceived boundary of the imaged body structure, either manually or automatically. A three-dimensional (3-D) candidate shape estimate of the body structure is then generated automatically from the single image and the selected boundary points.

According to another aspect of the invention, a body structure (such as a heart ventricle) is scanned (preferably using an ultrasound transducer) in a plurality of scan planes to produce a corresponding plurality of two-dimensional, cross-sectional image of the body structure. Initial boundary points are then selected on a perceived boundary of the imaged body structure for each image, either manually or automatically. A three-dimensional (3-D) candidate shape estimate of the body structure is then generated automatically from the image and the selected boundary points. A composite 3-D shape estimate is then computer from the plurality of candidate 3-D shapes.

The three-dimensional (3-D) shape estimate(s) are preferably generated by minimizing a cost function that includes the spatial difference between the initial boundary points and a plurality of reference shapes, where each reference shape is a discretization of at least one of a population of body structures of the same type as the scanned body structure of the patient, and the cost function includes shape orientation variables. The reference shapes may be either two-dimensional or three-dimensional.

The orientation of the scan plane(s) and the location of the initial boundary points may be selected at user discretion. Each scan plane preferably corresponds to a predetermined imaging view.

Each reference shape is preferably represented as a set of elements. Each element is then preferably labeled according to a region of the body structure it corresponds to, and each initial boundary point is preferably labeled according to the region of the body structure it is perceived to lie in. The spatial difference in the cost function is then computed as a function of the distance between each initial boundary point and a closest, similarly labeled element.

A 3-D characteristic of the body structure may also be computed from any three-dimensional (3-D) candidate shape, or from the composite shape. A particularly useful 3-D characteristic is volume. If the body structure is a heart ventricle, the ventricle may then be scanned at the times of diastole and systole and the invention may calculate the ventricle's ejection fraction (or cardiac output, or other volume-related parameter) as a function of the calculated volumes at the times of systole and diastole.

The procedure the invention uses to create the (3-D) candidate shape may also be used to correct misregistration of existing 3-D shape data.

### BRIEF DESCRIPTION OF THE DRAWINGS

FIG. 1 is a top level or overview flow chart that generally defines the steps of the method according to the invention for automatically delineating the borders of a patient's body structure based on images of the structure.

FIG. 2 illustrates block diagram of a system in accordance with the present invention, for use in imaging the heart (or other organ) of a patient and to enable analysis of the images to determine cardiac (or other types of) parameters.

FIG. 3 is a schematic cross-sectional view of the left ventricle, ultrasonically imaged along a longitudinal axis, indicating anatomic landmarks.

FIG. 4 is a flow chart illustrating the steps followed to manually select border points from a heart image.

FIG. 5 is a flowchart illustrating the steps of the shape optimization process.

FIG. 6 is a flow chart illustrating the steps followed to generate the knowledge base of shapes.

FIG. 7 is an illustration of part of a labeled triangular mesh, which can be used to represent a shape.

FIG. 8 is a flow chart illustrating the steps followed to detect new border points.

FIG. 9 is a schematic diagram of a shape intersected by an imaging plane.

FIG. 10 is a flow chart illustrating the steps followed to generate the image knowledge base of border templates.

FIG. 11 is a flow chart illustrating the steps followed to combine image information.

### DETAILED DESCRIPTION

While the present invention is expected to be applicable to imaging data produced by other types of imaging modalities such as computed tomography (CT) and magnetic resonance imaging (MRI), in a preferred embodiment discussed below, ultrasound imaging is employed to provide the imaging data. However, it will be understood that the present invention is not limited to use with ultrasound imaging data. Moreover, the invention is described below in the context of delineating the boundaries of cardiac structures, because it is in this context that the invention is believed to be most advantageous and will be most used. In particular, merely by way of example, the invention is described in the context of delineating the shape of the left ventricle. As will be understood from the description below, however, the invention may be used to improve or determine the boundaries of other body structures as well; any modifications to the preferred embodiment of the invention—if needed at all—will be obvious to those skilled in the art.

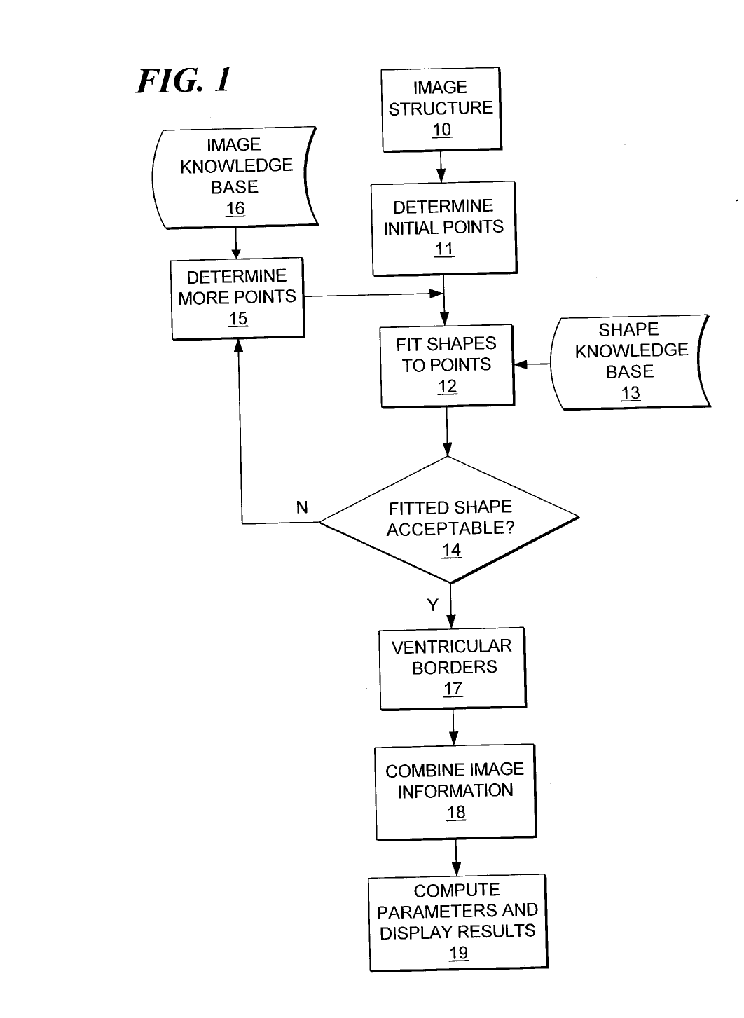

FIG. 1 is a top level or overview flow chart that broadly defines the steps of a preferred method used in the present invention for automatically detecting the borders of the left ventricle of the heart (or other body structure) and for producing a shape based upon an image of the structure. As mentioned above, in the preferred embodiment of the invention, the image is obtained using conventional ultrasound imaging techniques. The illustrated steps (shown as the blocks of FIG. 1) are described in greater detail below, but are summarized here by way of an “overview” of the more detailed description.

Step 10: An image of the body structure of interest is acquired in any conventional manner. In the context of ultrasonic imaging, this involves obtaining one or more 2-D views. As is explained further below, for imaged body structures such as the left ventricle, the invention is able to compute a 3-D representation based on only a single 2-D view; additional 2-D views improve the 3-D representation.

Step 11: Initial points are selected on the perceived boundary of the imaged structure.

Step 12: A shape knowledge base 13 contains representations of several examples of the same body structure as is imaged in step 10, but for different patients under controlled circumstances. In other words, the shape knowledge base 13 contains several predetermined, “reference” or “control” shapes. In step 12, a combination of the pre-stored reference shapes is calculated that in some sense best matches the points of the current image that have been selected.

Step 14: A determination is made as to whether the shaped computed in Step 12 is good enough. If it is not, then the system proceeds to step 15 (see below); if it is, then the system proceeds to step 17 (see below).

Step 15: Additional points are chosen on the perceived structure boundary based on the gray-scale image acquired in step 10 and on image feature information contained in an image knowledge base 16. Together with the initially chosen points (step 11), the new points form another input to the shape-fitting routine of step 12.

Step 17: The satisfactory shape estimate created in step 12 provides a 3-D estimate of the ventricle. The system can then either simply display the border for the clinician, or it can proceed with additional processing based on the 3-D estimate of the ventricle.

Step 18: In this optional step, optimal shapes determined from two or more images acquired as different views are combined into a single 3-D shape estimate.

Step 19: In this optional step, various cardiac parameters may be calculated based on the combined 3-D shape estimate generated in Step 18.

Except for the steps that require or allow operator involvement (such as to do the initial ultrasound scan), the various steps according to the invention all comprise processing routines that are computer instructions stored in the memory and executed by the processor(s) of whatever imaging system (for example, ultrasound machine) is used. Note that it would be possible to incorporate the invention in a “networked” or “remote analysis” system, in which the scan of the patient is conducted using one system, but the data are transferred to a different computer system for analysis and for performing the remaining steps of the invention. If desired, results could then be sent back to the scanning system, or to any other system, for viewing, interpretation, and further analysis. The different steps and other features of the invention will now be described individually in greater detail.

Image acquisition (Step 10)

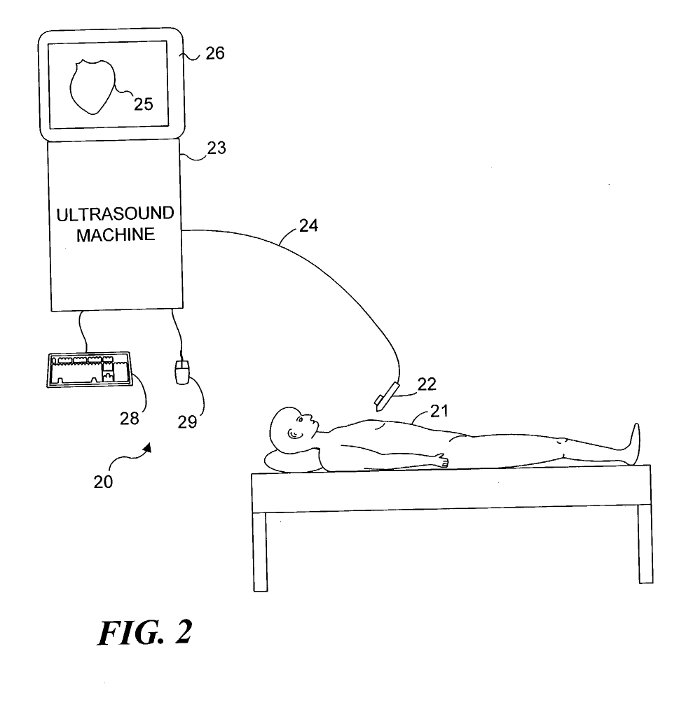

FIG. 2 illustrates a system 20 for producing ultrasonic images of the heart of a patient 21. An ultrasound transducer 22 is driven in any conventional manner to produce ultrasound waves in response to a signal conveyed from an ultrasound machine 23 over a cable 24. The ultrasound waves produced by ultrasound transducer 22 propagate into the chest of patient 21 (who will normally be lying on his/her left side, although this disposition is not shown in FIG. 2) and are reflected back to the ultrasound transducer. Conventional input devices such as keyboard 28 and cursor-control device 29 (such as a mouse, trackball, etc.) are also preferably included to allow the operator to set parameters of a scan, select image points, enter labels, etc.

The returned echo signals convey image data indicating the spatial disposition of organs, tissue, and bone within the patient's body, which have different acoustic impedances and therefore reflect the ultrasound signal differently. The reflected ultrasound waves are converted into a corresponding signal by the transducer 22 and this signal, which defines the reflected image data, is conveyed to conventional processing circuitry in the ultrasound machine 23. The ultrasound machine 23 then produces and displays an ultrasound image 25 on a display 26. The general operation of an ultrasonic imaging system is well known and is therefore not described in greater detail here. For the purpose of understanding this invention one should simply recall that it is possible to generate 2-D gray-scale (or color) images of specified portions of the heart using ultrasound.

In the preferred embodiment of the invention, at least two views of the patient's heart (or other anatomy of interest) are taken. In other words, the patient's heart (or other organ) is preferably imaged with the ultrasound transducer 22 disposed at two or more substantially different positions (for example, from both the apical and parasternal windows of the patient's chest) and at multiple orientations at each position; the resulting imaging data will then include images for a plurality of different imaging planes through the heart. The image planes may be substantially freely oriented relative to each other—the invention does not require that the image planes be acquired in parallel planes or at fixed rotational angles to each other. On the other hand, in most ultrasonic imaging, of the heart as well as of other body structures, there are usually a number of “standard” views that the sonographer will acquire. Two or more such standard views (preferably non-parallel) are suitable as the different image planes.

The images 25 are preferably recorded at a plurality of time points in a cardiac cycle including, at a minimum, an end diastole, when the heart is maximally filled with blood, and at end systole, when the heart is maximally contracted. By way of example, the preferred embodiment of the invention is disclosed in connection with automatically determining the endocardial and epicardial contours of the left ventricle. It should be emphasized, however, that the invention is equally applicable and useful for automatically determining the contours of other chambers of the heart, so that other parameters generally indicative of the condition of the patient's heart can be evaluated, as discussed below.

The organ borders in these images 25 are typically not clean lines, but instead, are somewhat indefinite areas with differing gray-scale values. Thus, it can be difficult to determine the contours of the epicardium and endocardium in such images.

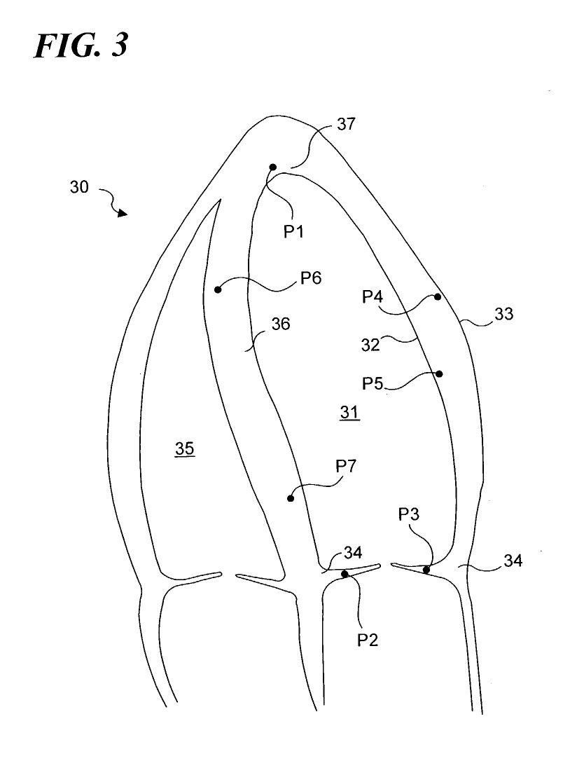

FIG. 3 shows a schematic representation 30 of an apical four-chamber view of the patient's heart, including a left ventricle, with its enclosed chamber 31. The left ventricle is defined by the endocardium 32 and the epicardium 33. Additional anatomic landmarks are the mitral valve annulus 34, the right ventricle 35, the interventricular septum 36, and the apex of the left ventricle 37.

Initial point selection (Step 11)

Selection of initial boundary points may be either wholly manual, or automatic, or a combination of the two—initial manual selection followed by automatic selection of additional points and/or adjustment of the manually selected points. Manual selection of points in a displayed ultrasound image is already a routine procedure, for example, when determining the femur length of an imaged fetus. Typically, this involves moving an on-screen cursor and “clicking” on the desired initial points, or selecting and adjusting an initial template contour from a menu. The processing circuitry of the ultrasound machine then converts the selected points into coordinates in the coordinate system of the displayed image so that the points can be used in the various routines of this invention. The invention may use any such method. In FIG. 3, several user-selected points P1-P7 are shown by way of example.

Manual selection of initial points has the advantage that the user will usually be able to quickly interpret the displayed image and place initial points in particularly informative positions; for example, a skilled sonographer could readily see to put points P2 and P3 on the mitral annulus. It would be possible, however, to configure the system according to the invention for automatic or “semi-automatic” selection of initial points using any known method, such as those described below.

For cardiac studies it is normal practice to position the heart structure in a consistent region of the image, depending on the view. A typical location for the desired structure border can be predetermined, for example by averaging border locations from several studies. This typical border can be sampled to automatically provide initial point selection.

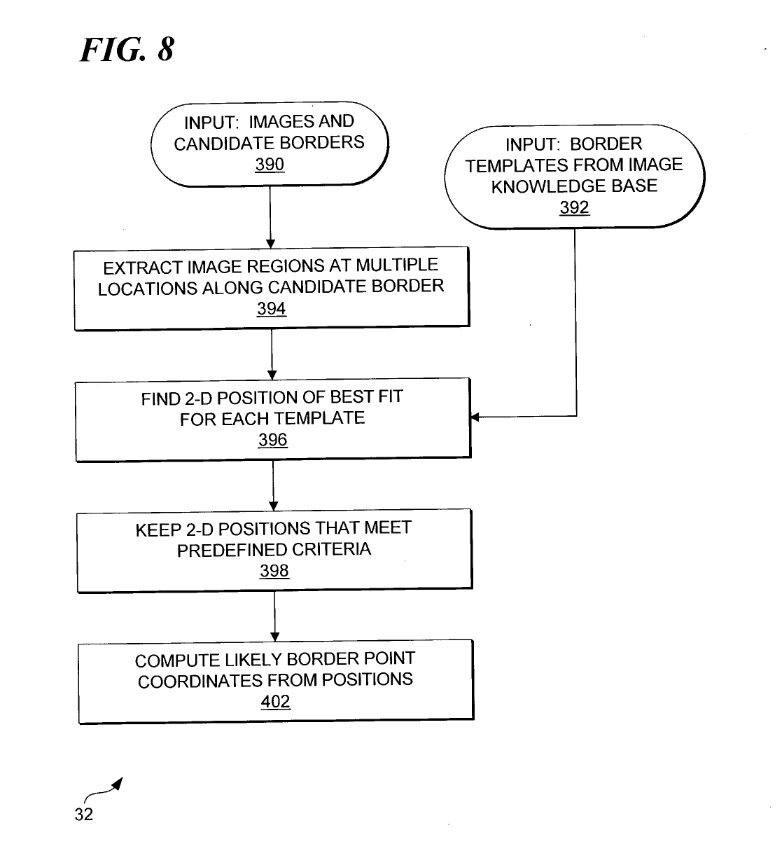

In a related method, the typical border can be used to locate search regions for the desired initial points. These initial points can be automatically detected by template matching as in FIG. 8.

These known methods may be combined with binarization of the original gray-scale image, followed by morphological filtering. This technique is disclosed, for example, in U.S. Pat. No. 5,588,435 (Weng, et al., Dec. 31, 1996, “System and method for automatic measurement of body structures Morphologic Filtering”) and tends to work well where the expected boundaries are relatively thick and smooth, such as the endocardium and the epicardium.

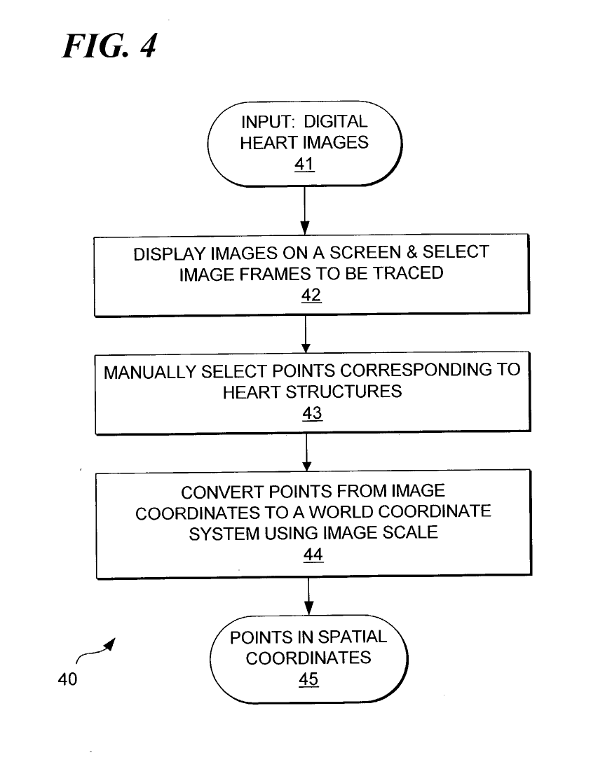

FIG. 4 gives the details of the step of manually selecting initialization points on an ultrasound image. The user (usually, sonographer) reviews the image on a display (block 41), such as the existing display 26 (FIG. 2) of the ultrasound machine and selects frames that show specific anatomic landmarks, at certain time points in the cardiac cycle, usually the time of end diastole and end systole, as noted in a block 42. An ECG can be recorded during the imaging process to provide cardiac cycle data for each of the image planes scanned that are usable to identify the particular time in the cardiac cycle at which that image was produced. The identification of the time points is assisted also by review of the images themselves, to detect those image frames in which the cross-sectional contour of the heart appears to be maximal or minimal.

The points of interest are then located in the image and selected manually using a standard pointing device, as indicated in a block 43. Preferably, the selected points include the apex of the left ventricle, the aortic annulus and the mitral annulus; other anatomical landmark structures that may be used include the left ventricular free wall and interventricular septum. The coordinates of these points are converted in any known way from pixel units to spatial units based on the image scale in a block 44.

One advantage of the invention is that it is not necessary for the sonographer to precisely identify any particular landmarks, or to scan the heart so that the scan plane passes through precisely specified points. There is thus no requirement for a one-to-one mapping between the selected initial boundary points and corresponding points of reference shapes in the shape knowledge base. Rather, it is sufficient that the sonographer provide any standard view with normal precision such that it includes the main sub-structures (for example, mitral annulus, epicardium, etc.) defining the anatomy of interest. The user may then select initial boundary points substantially arbitrarily, at his own discretion, the only requirement being that the sub-structures on which the points lie should be automatically or manually identifiable; this suffices to permit the imaged sub-structures to later be registered with portions of the stored reference shapes that are of the same type (structure).

Recall that each image frame corresponds to a planar cross-section of the 3-D structure of interest (in this example, the left ventricle). Regardless of the degree of automation, the result of the initial point selection process will therefore be that the structure of interest will be represented as a set E of the m selected points forming an estimate of the 2-D boundary of the intersected 3-D structure. Thus E=(p₁, p₂, . . . pₘ), where pⱼ (j=1,m) are the indicated points. Recall that each pj is a point in R³.

Constructing shape knowledge base 13

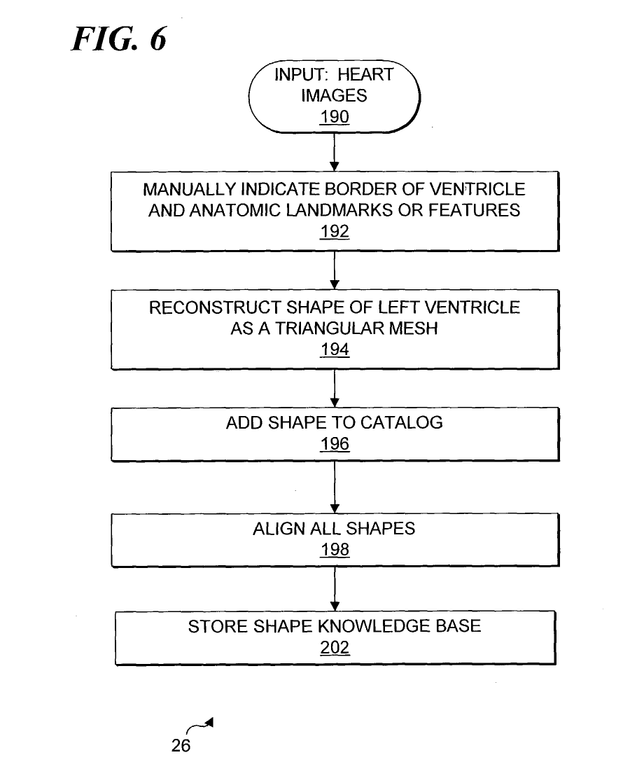

Assume as in the illustrated example that the body structure to be modeled is the left ventricle. According to the invention, the shape knowledge base 13 is built up by representing the shapes of left ventricles imaged in prior studies that have been manually or automatically processed for a number of other hearts. A plurality of shapes of the left ventricles in a population of hearts exhibiting a wide variety of types and severity of heart disease is thus used to represent variations in the shape of the left ventricle. Specifically, based on an analysis of this population of hearts, the shape knowledge base 13 is developed using the steps shown in FIG. 6:

For each of several ultrasound images of the left ventricle of the population of hearts (step 190), a clinician manually indicates (for example, by selecting points, tracing, positioning contours, etc.) the border of the left ventricle, and preferably also anatomic landmarks or features (step 192). Because this may be done off-line and in advance, a skilled clinician will be able to locate a large number of border points accurately, or at least a much larger number than will normally be selected in the step of initial point selection (step 11 in FIG. 1). Preferably, the set of manually indicated borders includes imaging data for multiple cardiac phases from at least five imaging planes for each of the hearts; these planes preferably include standard clinical views. Any known sensing device is then used to monitor the position and orientation of each image as it is acquired.

As shown as block 194, a shape is then reconstructed from these borders for the portion of the heart of interest. One suitable reconstruction method is disclosed in U.S. Pat. No. 5,889,524 (McDonald, et al.). These representations, which form “reference” or “control” shapes, are stored in a shape catalog (step 196) using any known data structure as sets of coordinates and labels in the memory of the ultrasound machine. The shapes in the catalog are then aligned (step 198) using any known method; in other words, the sets of coordinates of the shapes in the catalog are transformed so that they are spatially registered to correspond to a predetermined reference orientation. The set of all the aligned catalog shapes yields the shape knowledge base (step 202).

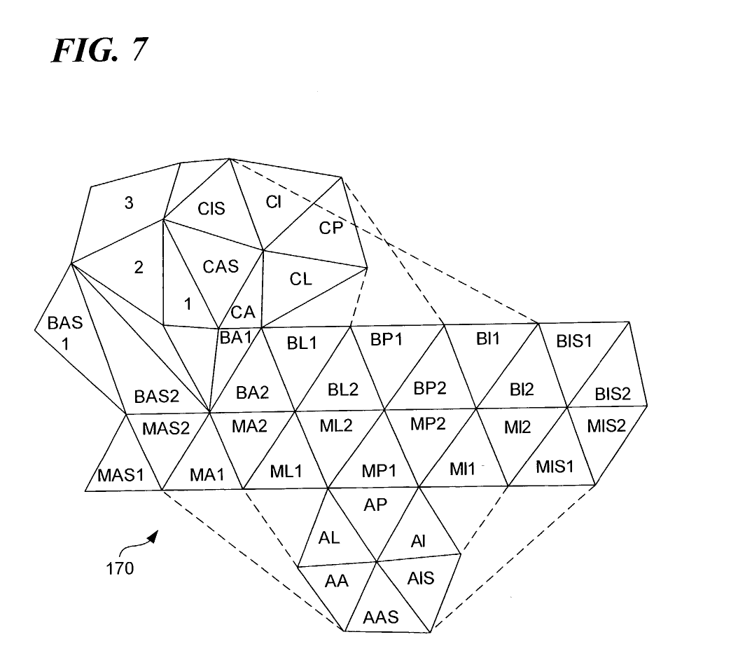

An example of one pre-stored control shape 170 is shown in FIG. 7. In this example, each 3-D reference shape is represented as a set of triangles, each of which is labeled according to the region of the ventricle it represents. In the preferred embodiment of the invention, shapes are represented by triangular meshes. A triangular mesh includes sets of faces, edges, and vertices. Each face is a triangle in R³ and contains 3 edges and 3 vertices. Each edge is a line segment in R³ and contains 2 vertices. Each vertex is a point in R³. The vertex positions are thus sufficient to determine the shape of the mesh. The vertices, edges, and faces of a mesh are referred to collectively as the simplices (singular “simplex”) of the mesh. A typical triangular mesh used to model the left ventricle has 576 faces, although this will of course depend on the structure to be modeled and the preferences of the designer.

The simplices of the mesh in FIG. 7 are labeled using any known input is method to indicate their association with specific anatomy. Thus, the face labels AL, AP, AI, AIS, AAS, and AA all start with the letter “A” to indicate that they are associated with the apex region of the left ventricle. Labels starting with “M” indicate a mitral feature, and so on. As in U.S. Pat. No. 5,889,524, data and shape labeling is used in this preferred embodiment of this invention to constrain the distance calculation (see below), resulting in faster and more robust shape fits.

Each shape in the shape knowledge base 13 can be stored as the set of coordinates of its vertices (after alignment). Thus Sᵢ=(vᵢ₁, vᵢ₂, . . . , vᵢₙ), where Sᵢ is the i'th shape stored in the knowledge base 13 and vᵢ₁, vᵢ₂, . . . , vᵢₙ are the n vertices defining the representation of Sᵢ. Recall that each vᵢⱼ is a point in R³.

Although this preferred embodiment of the invention is described in terms of triangular meshes, any known shape representation may be used as long as it supports geometry optimization and averaging. Examples of alternative representational elements include subdivision shapes, polygons with more than three edges, non-planar surfaces, and splines, including NURBS (Non-Uniform Rational B-Splines). Note that all such representations are discretizations of the control images of the population of hearts in the sense that the continuous geometry of the anatomy is represented as a finite set of numbers. It is therefore not necessary to store all the points that define the reference shapes; rather, depending on the choice of representational elements, it may be more efficient to pre-store only control parameters from which the reference shapes can be computed as needed.

Note that it is not necessary for the reference shapes to be three-dimensional, although this is preferred. Rather, 2-D reference shapes may also be acquired, stored and used for shape fitting as long as it is known what planar cardiac view each represents. Moreover, it is not strictly necessary to build up the shape knowledge base through imaging other hearts, using ultrasound or other energy—it would also be possible to use numerical representations of heart structures that are obtained through pathological examination and measurement of a population of hearts. Of course, one could also include both imaged and measured reference shapes as long as they are represented in a consistent manner.

As one other alternative, the reference shapes in the knowledge base 13 could be those derived in any manner (including though use of this invention) from previous scans of the patient's own heart (or other body structure). The goodness of fit value used in the shape-fitting routine (see below) would then indicate how much the shape of the patient's imaged body structure (heart or other) changed over time.

Shape-fitting (Step 12)

The primary inputs to the shape-fitting routine (step 12 of FIG. 1) in the preferred embodiment of the invention are the data structure E, which contains the coordinates of the selected points of the current image frame (from step 10 of FIG. 1), the reference shapes S, and transformation parameters \overline{α} for the references shapes. The transformation parameters \overline{α} are preferably the parameters of a Euclidean transform, which specify the fitted shape's size, location, and orientation.

In this preferred embodiment of the invention, a candidate shape S_{c} is computed as the weighted linear combination of all Sᵢ, after transformation according to the parameters \overline{α}, that best fits selected points E. In other words, the system according to the invention finds the weights wᵢ and parameters \overline{α} that minimize a cost function C of the following form:

$$C = ‖ E - α ( {\sum }_{i} {w}_{i} \cdot {S}_{i} ) ‖$$

Where α(·) is the function representing the Euclidean transformation of the linearly combined shapes Sᵢ into the orientation specified by the parameters \overline{α}. In other words, a single shape is formed from a “morph” or “composite” of the shapes in the shape knowledge base, and then this composite shape is “moved around” until it exhibits a boundary that most closely matches the one the user sees on his display screen. Any known norm, that is, the goodness-of-fit measure, may be used to determine which shape gives the best fit with the indicated points. The preferred method, however, is as follows:

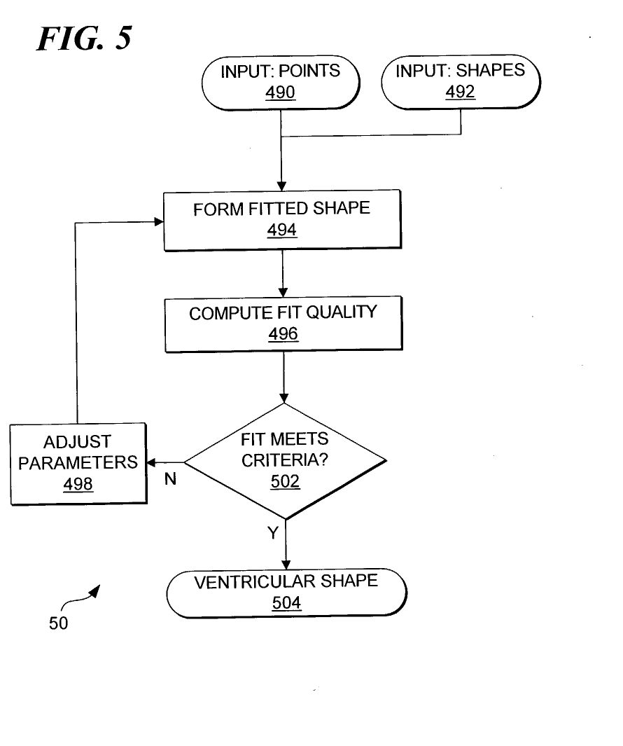

Given the user-indicated (and/or automatically determined) border points (input 490 in FIG. 5) and the reference shapes (input 492), shape-fitting involves optimizing the adjusting vertex positions (block 494) until the correspondence between the border points and a composite of the reference shapes is maximized. In the preferred embodiment of the invention, the fit quality measure includes distances from the data points 490 to the composite shape, the shape area, the shape smoothness, etc. The preferred optimization minimizes the projection distance in the normal direction between the data points and the nearest faces of the candidate composite shape. The required vertex adjustment may be done using standard methods for numerical optimization, such as conjugate gradients, to optimize any conventional measure of fit quality, which is determined in a step 496.

Vertex positions can be adjusted directly by a numerical optimization algorithm, such as is discussed in U.S. Pat. No. 5,889,524. However, to constrain the fit to anatomically reasonable shapes, it is easier to re-parameterize the shape geometry, separating alignment parameters from ones controlling shape. In the preferred embodiment of the invention, this task is done by morphing, in a manner similar to that taught by Fleute and Lavallee. The weights wᵢ determine the “shape” of the shape, while the parameters \overline{α} of a Euclidean transform determine the fitted shape's size, location, and orientation. Fitting the shape in this way restricts its shape to be consistent with the observed shapes in the knowledge base. A decision block 502 determines if the fit meets a predetermined criterion, and, if not, the parameters (block 498) and weights are adjusted and the shape-fitting routine and the fit is iterated. Once an acceptable fit is obtained, the result is a candidate ventricular shape, as shown in block 504.

Note that by including orientation (alignment) parameters as variables in the shape-fitting optimization, the resultant 3-D shape estimate will be correctly oriented relative to the plane of the input scan image. Here, “correct” means that the spatial orientation of the 3-D shape estimate relative to the scan plane is the same as the spatial orientation of the actual body structure (for example, left ventricle) relative to the scan plane. Observe that orienting the 3-D shape estimate relative to the scan plane is equivalent to determining the orientation of the scan plane relative to the actual scanned body structure.

Decision to accept estimated best shape (step 14)

There are different ways to determine whether the fitted shape computed in step 12 is good enough. One possible acceptance condition is that the optimization algorithm used to find the fitted shape had a residual error (cost) less than some predetermined threshold. As FIG. 1 illustrates, the process of finding a “best” shape estimate, then adding more points, then finding a new best shape estimate, etc., can be iterated any number of times.

The results are displayed and an acceptance decision is made in a block 19. This acceptance decision is based on “goodness of fit” parameters computed in block 16 and 18 and optionally, can depend upon operator approval of the shape or borders.

It is also possible to allow the operator to determine if the results are acceptable. The border obtained by intersecting the shape (endocardial or epicardial) of the fitted shape of the left ventricle in any imaging plane could in such case be displayed for review and verification by the operator. If any border is not acceptable to the operator, then the system can proceed with step 15 (below) to acquire additional points and achieve a closer match between the computed border and the observed images of the patient's heart. If the operator is satisfied with the results of shape-fitting, it will not be necessary to determine more points.

Multiple iteration is not necessary, however. Rather, it would be possible simply to always proceed from step 12 to step 15, and then one more time to step 12, after which it is assumed that the fitted shape is good enough. In this case, there is no “branching” decision step 14 at all. This single-pass routine will in most cases produce satisfactory results and was in fact the method chosen in a prototype of the invention.

Determination of additional points (step 15)

Border point detection is preferably performed to enable further refinement of the match between the shape and the image data for the heart of the patient. Likely additional border point locations are detected in the images of the patient's heart, near the candidate borders (intersection curves of the fitted shape and the image plane). One way to obtain additional border points would be to prompt the user to enter additional points manually. Details of the preferred, automatic method, are shown in FIG. 8 and are discussed below.

An image knowledge base 16 includes gray-scale templates derived from images of the left ventricle. As with the shape representations in the shape knowledge base 13, the templates in the image knowledge base 16 are determined from prior studies that have been processed for a number of other hearts. These templates are used to determine additional border points.

The steps carried out for additional border point detection are shown in FIG. 8. Given a candidate shape (the result of the shape-fitting step 15), a search region of the image is extracted (step 394) according to a previously defined size, shape, and location relative to the candidate border. This region has a type (for example, mitral valve annulus or other standard landmark) based on a face and view consistent with the border templates included in the knowledge base. The border templates in the image knowledge base 16 thus preferably correspond to such relatively clearly identifiable structures and landmarks.

In step 396, the border template from the image knowledge base 16 with the same type is applied to the search image region along the candidate border. A different border template is therefore used for each such image region along the candidate border. A similarity measure is then computed for different border template positions within the search image region. The preferred similarity measure is cross correlation because of its known robustness and relative gain-independence. The position with highest similarity is then selected in step 396, and its origin is used as a candidate border point. In step 398, if the similarity measure exceeds a predetermined threshold, then this position is retained for use in determining a corresponding likely additional candidate border point having coordinates for use in the next shape optimization to determine another candidate shape.

In other words, in step 15, gray-scale border templates pre-stored in the image knowledge base 16 are matched (using, for example, cross-correlation) with the portion of the current gray-scale image of the same type (mitral valve annulus, etc.) When the best match is found for the portion, additional points can be chosen automatically (step 402) by selecting them, for example, with equal distribution between end points.

Border presentation (step 17)

As mentioned above, at this point, the system will have a 3-D representation of the ventricle (or other body structure). A display of this representation may be all the user wants, in which case the invention need not perform any further processing. Any known method may be used to display (project) the 3-D representation on the 2-D display screen of the ultrasound machine.

Alternatively each image may be overlaid with the border determined as the intersection of the image plane and the 3-D representation.

Image knowledge base 16

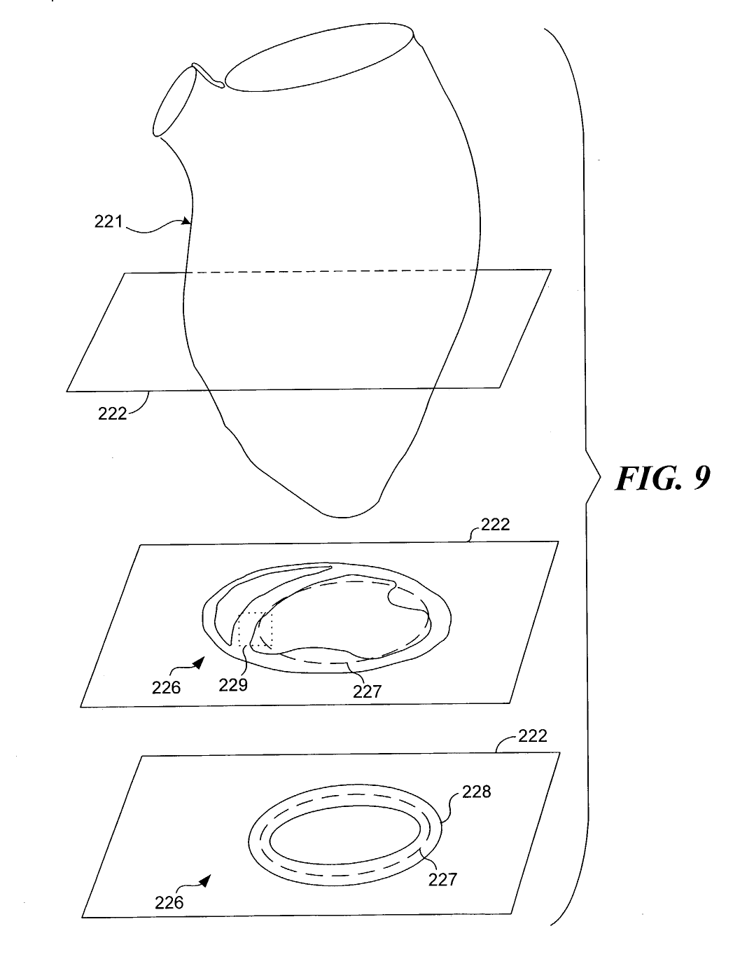

As is illustrated in FIG. 9, the intersection of a 3-D shape 221 with an image plane 222 comprises a series of line segments, each line segment being associated with a face in the shape. In an exemplifying image 226 in a plane 222, the intersection is a border 227. The border 227 is used to locate image regions 228 that are spaced apart around the border.

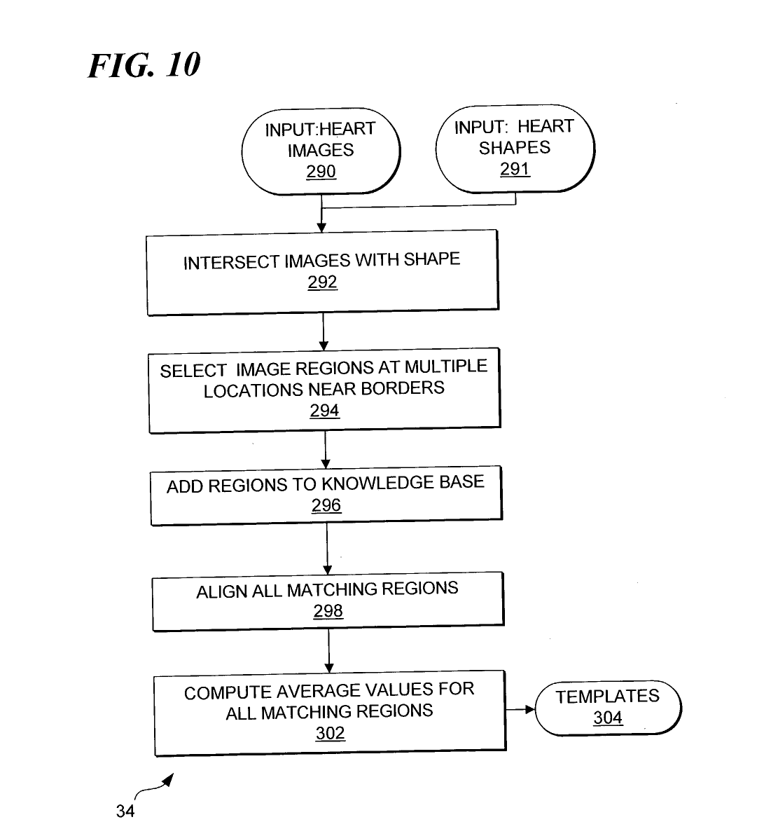

The image knowledge base 16 of border templates contains the border templates or reference patterns determined for each view and face by averaging smoothed gray-scale values from previously acquired and processed studies, as shown in FIG. 10. The inputs for developing the knowledge base include heart images 290 (gray-scale) and heart shapes 291 (simplex representations) for all of the hearts to be used for the knowledge bases. In a step 292, each image in the study to be added to the image knowledge base is computationally intersected with the shape determined for that study, based on manual or automated processing; in other words, a 2-D cross section is determined though the structure for which a template is needed. This intersection comprises a series of line segments, which in turn comprise borders; each line segment corresponds to a face of the shape. A region of predetermined size, shape, and location relative to the line segment is then selected (step 294) using any known method from the image in the vicinity of each line segment and copied. Typically, the region surrounds the center point of its border line segment. In FIG. 9, one such region is shown within the dotted box 229.

Each region is appended to the image knowledge base 16 in step 296. Each region is then assigned a type in the knowledge base that is determined by its cardiac timing, face and view. These views are preferably given standardized labels based on orientation (for example, parasternal or apical) and anatomic content (for example, four chamber or two chamber). Matching image regions are aligned in step 298. In step 302, image regions of the same type are combined to form templates 304, which are used in step 15 (FIG. 1) for border point detection. Each template is assigned an origin whose coordinates correspond to the center of the line segment comprising a border.

The full shape-fitting and adjusting features of the invention are most naturally used to generate a new 3-D representation of an anatomy of interest. This is not their only use, however—the invention's novel shape-fitting and adjusting techniques could also be used to fix misregistration in existing 3- D shape data. In this case, the 3-D shape data would be input in any known manner, then shape -fitted (step 12) with reference to the shapes pre-stored in the knowledge base 13. If the gray-scale image from which the 3-D shape data were derived is available, then initial points could be selected on specified perceived boundaries (of different 2-D displayed projections). Additional points could also be generated in step 15 as described above and a better 3-D shape estimate would in many cases be provided.

Image combination (step 18)

The invention provides a 3-D representation (shape estimate) for each image frame. In other words, the invention is able to produce a properly oriented 3-D shape estimate given only a single 2-D input image. According to a further embodiment of the invention, however, the fitted shape estimates created from two or more single images are combined (step 18) to generate a single 3-D shape, which is most cases will be a better estimate than one produced from only a single image.

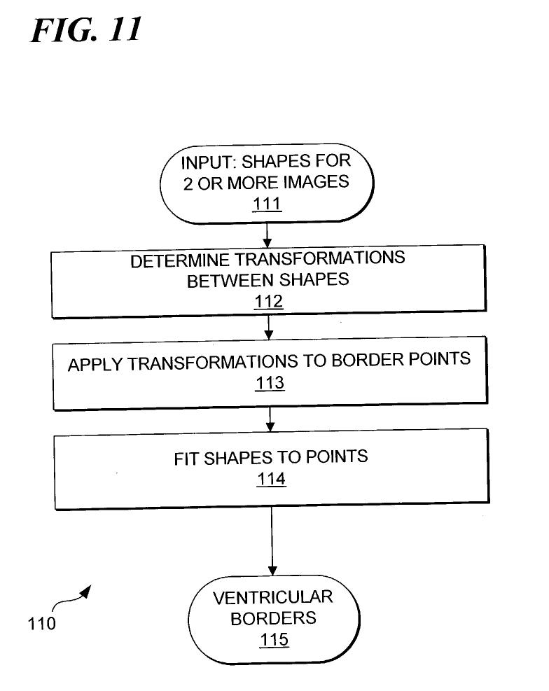

As FIG. 11 shows how information from two or more images may be combined to produce an improved fit: The 3-D shape estimates computed for single images (block 111) are used to determine the parameters of one or more transformations in step 112. One way to determine these parameters is by applying the known Procrustes transformation, which is a linear transformation (translation, rotation and scaling) between sets of corresponding points. In the context of this invention, all or any subset of shape vertices may be used as the basis of the transformation. The transformation is then applied to border points to place them in a consistent 3-D coordinate system using the parameters determined in step 113. The fitting process illustrated in FIG. 5 and described above is then applied in step 114 to produce a new shape. This shape may then be intersected with the image planes to derive ventricular borders (output 115). Observe that the invention can produce the correctly oriented 3-D shape estimate from the multiple input views without knowledge of the exact absolute or relative spatial orientation of the views themselves.

Parameter computation and display (step 19)

At this point, assuming that the portion of the heart being evaluated is the left ventricle, the method will have produced an output comprising shapes representing the endocardial, epicardial, or both surfaces of the left ventricle. These shapes can be used to determine cardiac parameters such as ventricular volume, mass, and function, ejection fraction (EF) and cardiac output (CO), wall thickening, etc., as indicated in block 19 of FIG. 1. Consider, for example, EF calculation, which is closely related to CO calculation: Assuming the left ventricle is the imaged anatomy, each “product” of the invention is a properly (and automatically) oriented 3-D representation of the ventricle. Known algorithms can then be applied to calculate the volume of the 3-D representation. If one were to scan the ventricle at diastole and then at systole, these volumes can be used in conventional calculations of EF and CO. Note that this means the invention makes it possible to calculate such parameters as EF and CO with only one, two, or a few 2-D image frames, with no need for a real-time 3-D ultrasound. On the other hand, because only a few (as few as one) 2-D image frames are needed to obtain an anatomically correct 3-D reconstruction of the ventricle, the invention makes it possible to estimate, EF, CO, or other volume-based parameters in real time, as long as the processor(s) of the ultrasound machine is fast enough to perform the necessary calculations.

What is claimed is:

1. A method for determining the shape of a body structure of a patient comprising the following steps:
A) scanning the body structure in a scan plane to produce a single two-dimensional, cross-sectional image of the body structure;
B) selecting initial boundary points on a perceived boundary of the image of the body structure; and
C) automatically generating a 3-D shape estimate of the body structure from the single image and the selected boundary points, including automatically orienting the 3-D shape estimate spatially to correspond to the spatial orientation of the body structure relative to the scan plane.

2. A method as in claim 1, in which:
the step of automatically generating the three-dimensional (3-D) shape estimate comprises minimizing a cost function including the spatial difference between the initial boundary points and a plurality of reference shapes;
each reference shape is a discretization of at least one of a population of body structures of the same type as the scanned body structure of the patient; and
the cost function includes shape orientation variables.

3. A method as in claim 2, in which the reference shapes are three-dimensional.

4. A method as in claim 2, in which the reference shapes are two-dimensional.

5. A method as in claim 2, in which the orientation of the scan plane and the location of the initial boundary points are selected at user discretion.

6. A method as in claim 5, in which the scan plane corresponds to a predetermined imaging view.

7. A method as in claim 2, further comprising:
representing each reference shape as a set of elements;
labeling each element according to a region of the body structure it corresponds to;
labeling each initial boundary point according to the region of the body structure it is perceived to lie in; and
computing the spatial difference in the cost function as a function of the distance between each initial boundary point and a closest, similarly labeled element.

8. A method as in claim 1, further comprising:
doing steps A)-C) at least twice, at different times, thereby generating at least two three-dimensional (3-D) shape estimates of the body structure; and
calculating a 3-D characteristic of each 3-D shape estimates.

9. A method as in claim 8, in which the 3-D characteristic is volume.

10. A method as in claim 9, in which the body structure is a heart ventricle, the method further comprising:
scanning the heart ventricle at the times of diastole and systole;
calculating the ventricle's ejection fraction as a function of the calculated volumes at the times of systole and diastole.

11. A method as in claim 1, further comprising selecting the initial boundary points automatically.

12. A method for determining the shape of a body structure of a patient comprising:
A) scanning the body structure in a plurality of scan planes to produce a corresponding plurality of two-dimensional, cross-sectional image of the body structure;
B) for each image:
i) selecting initial boundary points on a perceived boundary; and
ii) automatically generating a three-dimensional (3-D) candidate shape estimate of the body structure from the image and the selected boundary points; and
C) computing a composite 3-D shape estimate from the plurality of candidate 3-D shapes.

13. A method as in claim 12, further comprising automatically determining the spatial orientation of the scan planes relative to the body structure.

14. A method as in claim 12, in which:
the step of automatically generating the three-dimensional (3-D) shape estimate comprises minimizing a cost function including the spatial difference between the initial boundary points and a plurality of reference shapes;
each reference shape is a discretization of at least one of a population of body structures of the same type as the scanned body structure of the patient; and
the cost function includes shape orientation variables.

15. A method as in claim 14, in which the reference shapes are three-dimensional.

16. A method as in claim 14, in which the reference shapes are two-dimensional.

17. A method as in claim 14, in which the orientation of each scan plane and the location of the initial boundary points are selected at user discretion.

18. A method as in claim 17, in which the scan planes correspond to predetermined imaging views.

19. A method as in claim 12, further comprising:
representing each reference shape as a set of elements;
labeling each element according to a region of the body structure it corresponds to;
labeling each initial boundary point according to the region of the body structure it is perceived to lie in; and
computing the spatial difference in the cost function as a function of the distance between each initial boundary point and a closest, similarly labeled element.

20. A method as in claim 12, further comprising calculating a 3-D characteristic from each 3-D shape estimate.

21. A method as in claim 20, in which the 3-D characteristic is volume.

22. A method as in claim 21, in which the body structure is a heart ventricle, the method further comprising:
scanning the heart ventricle at the times of diastole and systole;
calculating the ventricle's ejection fraction as a function of the calculated volumes at the times of systole and diastole.

23. A method as in claim 12, further comprising selecting the initial boundary points automatically.

24. A method for determining the shape of a ventricle of a heart comprising the following steps:
A) scanning the heart in a scan plane to produce a single two-dimensional, cross-sectional image that shows the ventricle;
B) selecting initial boundary points on a perceived boundary of the image of the ventricle; and
C) automatically generating a 3-D shape estimate of the ventricle from the single image and the selected boundary points, including automatically orienting the 3-D shape estimate spatially to correspond to the spatial orientation of the ventricle relative to the scan plane;
in which:
the step of automatically generating the three-dimensional (3-D) shape estimate comprises minimizing a cost function including the spatial difference between the initial boundary points and a plurality of reference shapes;
each reference shape includes a discretized representation of one of a population of ventricles; and
the cost function includes shape orientation variables.

25. A method as in 24, in which the orientation of the scan plane and the location of the initial boundary points are selected at user discretion.

26. A method for determining the shape of a ventricle of a heart comprising:
A) scanning the heart in a plurality of scan planes to produce a corresponding plurality of two-dimensional, cross-sectional image that shows the ventricle;
B) for each image:
i) selecting initial boundary points on a perceived boundary; and
ii) automatically generating a three-dimensional (3-D) candidate shape estimate of the ventricle from the image and the selected boundary points by minimizing a cost function that includes shape orientation variables and the spatial difference between the initial boundary points and a plurality of reference shapes, where each reference shape is a discretization of at least one of a population of ventricles; and
C) computing a composite 3-D shape estimate from the plurality of candidate 3-D shapes.

27. A method as in 26, in which the orientation of the scan plane and the location of the initial boundary points are selected at user discretion.

28. An imaging system for determining the shape of a body structure of a patient comprising:
A) a scanning device for scanning the body structure in a scan plane to produce a single two-dimensional, cross-sectional image of the body structure;
B) an input device for selecting initial boundary points on a perceived boundary of the image of the body structure; and
C) a computer program including computer instructions for automatically generating a 3-D shape estimate of the body structure from the single image and the selected boundary points, including automatically orienting the 3-D shape estimate spatially to correspond to the spatial orientation of the body structure relative to the scan plane.

29. A system as in claim 28, in which the computer program further includes computer instructions for automatically generating the three-dimensional (3-D) shape estimate by minimizing a cost function including the spatial difference between the initial boundary points and a plurality of reference shapes, each reference shape being a discretization of at least one of a population of body structures of the same type as the scanned body structure of the patient, and the cost function including shape orientation variables.

30. An imaging system for determining the shape of a body structure of a patient comprising:
A) a scanning device scanning the body structure in a plurality of scan planes to produce a corresponding plurality of two-dimensional, cross-sectional image of the body structure;
B) an input device for selecting initial boundary points on a perceived boundary in each image; and
C) a computer program including computer instructions for automatically generating a three-dimensional (3-D) candidate shape estimate of the body structure from the image and the selected boundary points for computing a composite 3-D shape estimate from the plurality of candidate 3-D shapes.

31. A system as in claim 30, in which the computer program further includes computer instructions for automatically determining the spatial orientation of the scan planes relative to the body structure.

32. A method for determining the shape of a body structure of a patient comprising the following steps:
inputting a set of 3-D shape data; and
minimizing a cost function of the spatial difference between the 3-D shape data and a plurality of pre-stored 3-D reference shapes to automatically generate a three-dimensional (3-D) shape estimate of the body structure, the 3-D shape estimate thereby correcting possible misregistration among the 3-D shape data.
